(19) United States
(12) Patent Application Publication
(10) Pub. No.: US 2026/0275001 A1
(43) Pub. Date: Sep. 17, 2026

(54) HORIZONTAL POLYMERIZATION REACTOR FOR PRODUCING PROPYLENE-BASED POLYMER AND METHOD FOR PRODUCING PROPYLENE-BASED POLYMER

(71) Applicant: JAPAN POLYPROPYLENE CORPORATION, Tokyo (JP)

(72) Inventors: Masato SHISHIDO, Tokyo (JP); Taiki SATO, Chiba (JP); Akari HAGA, Tokyo (JP)

(73) Assignee: JAPAN POLYPROPYLENE CORPORATION, Tokyo (JP)

(21) Appl. No.: 19/168,565

(22) PCT Filed: Mar. 30, 2023
(86) PCT No.: PCT/JP2023/013371

§ 371 Date: Sep. 24, 2025

(51) Int. Cl. C08F 2/01; B01J 8/00; B01J 8/08; C08F 10/06

(52) U.S. Cl. CPC C08F 2/01; B01J 8/004; B01J 8/08; C08F 10/06; B01J 2208/00752; B01J 2208/00867

(57) ABSTRACT

Provided is a horizontal gas phase-polymerization reactor for producing a propylene-based polymer which has the long-term operation stability hard to increase the differential pressure between the reaction chamber and the bearing chamber, also hard to deteriorate the agitating performance. The reaction container is divided into the reaction chamber and the bearing chamber; both the chambers are connected to each other in a state capable of communicating gas via the pressure equalization line; and the distance, from the position where the catalyst feed port of the reaction chamber and the catalyst feed nozzle are connected to the position where the reaction chamber and the pressure equalization line are connected, is 10% or more of the reaction chamber length.

### TECHNICAL FIELD

The disclosure relates to a horizontal polymerization reactor to produce a propylene-based polymer, and a method for producing the propylene-based polymer, in which the polymerization reactor is used.

### BACKGROUND ART

A propylene-based polymer which includes a propylene homopolymer and propylene copolymers is excellent in mechanical properties such as rigidity and heat resistance, good in moldability, capable of being produced at a relatively low cost, and high in adaptability to the environmental issues, the propylene-based polymer is thus applied to a wide range of the industrial use.

In those days when industrial production of the propylene-based polymer began, since the performance of catalysts was low, a production process of the propylene-based polymer necessitated a step for removing catalyst residue and atactic polymer, thus a process such as the slurry method using any solvent had been major.

After that, as the catalyst performance has been greatly improved, the necessity for removing the catalyst residue, the atactic polymer or the like has got low, and the gas phase polymerization method is a major process at present.

As a gas phase polymerization reactor for olefins such as propylene and ethylene, there is a known reactor that has a reaction vessel which is a reaction container of the polymerization reactor, and an agitator as a means for homogenizing a reaction system comprising raw material monomers and catalyst, wherein the agitator is disposed in the reaction vessel, and has an agitator shaft and agitating blades fixed on the agitator shaft.

Patent Document 1 discloses a vertical reactor as so-called, in which a cylindrical reaction vessel is arranged in a vertical direction, and an agitator having a vertical axis-rotatable agitator shaft is placed in the reaction vessel. On the other hand, Patent Document 2 discloses a horizontal reactor as so-called, in which a cylindrical reaction vessel is arranged in a horizontal direction, and an agitator having a horizontal axis-rotatable agitator shaft is placed in the reaction vessel.

In the case of producing the propylene-based polymer by the gas phase polymerization method with the use of the horizontal polymerization reactor, the catalyst is, in general, fed at an upstream region in the reaction vessel. The catalyst is fine particles, and propylene is polymerized on the surface or at the inside of the fine catalyst particles, and then particles of the propylene-based polymer are produced. The propylene-based polymer particles are gradually transferred to the downstream region in the reaction vessel while they are growing as the polymerization progresses, and grown powders of the propylene-based polymer are then discharged from the downstream side of the reaction vessel. Therefore, the existence probability of the catalyst fine particles fed into the reaction vessel and the propylene-based polymer particles with a small particle size (hereinunder, both the particles may be inclusively called as “fine powders of the propylene-based polymer” or simply as “fine powders”) gets higher, in the vicinity of a catalyst feeding zone which is the upstream region in the reaction vessel. The fine powders as described above get into a sliding interface between the agitator shaft of the agitator and the inner surface of the bearing to cause problems in the production process.

When the fine powders of the propylene-based polymer accumulate on a sliding interface between the agitator shaft and the inner surface of the bearing, a large friction load is generated. This friction load causes a deterioration in agitating performance, such as a reduction in agitating smoothness and stability, and a damage to the agitator shaft or the bearing, and it may finally result in problems such that the stability of polymerization reaction in the polymerization reactor, the ease of reactor maintenance, and the durability of the whole reactor deteriorate.

### Citation List

### Patent Documents

Patent Document 1: Japanese Patent Application Laid-Open (JP-A) No. S53-123487
Patent Document 2: Japanese Patent Application Laid-Open (JP-A) No. S63-223001

### SUMMARY OF INVENTION

### Technical Problem

The inventors of the present invention designed a horizontal polymerization reactor for the purpose of producing the propylene-based polymer by the gas phase polymerization method, and the horizontal polymerization reactor designed is characterized by the following features:
(1) The horizontal polymerization reactor is provided with a cylindrical reaction vessel arranged in a horizontal direction, and an agitator which has an agitator shaft rotating in a circumferential direction on a trunk portion of the reaction vessel and an agitating member fixed on the agitator shaft;
(2) A partition wall is disposed at one end side of an internal space of the reaction vessel, and the internal space of the reaction vessel is divided into a reaction chamber making a field for polymerization reaction and a bearing chamber adjacent to the reaction chamber by the partition wall, and a bearing for the agitator is placed in the bearing chamber;
(3) The agitator shaft is disposed in the reaction chamber with the agitator shaft being aligned with a central axis running in the length direction of the reaction vessel, and one end side of the agitator shaft is made to pass through the partition wall from the reaction chamber and extended into the bearing chamber, and the agitator shaft is axis-rotatably born by the bearing in the bearing chamber;
(4) The reaction chamber and the bearing chamber are connected to each other via a pressure equalizing line which serves as a gas communicating path; and,
(5) A purge gas feed line is connected to the pressure equalizing line, and a gas purge is carried out from the purge gas feed line to the pressure equalizing line.

The horizontal polymerization reactor possessing the features described above is improved in the following points:
(1) Since the bearing is placed in the bearing chamber of the reaction vessel, a risk that a fluid escapes out of the reaction vessel can be reduced in comparison with the case of placing the bearing outside the reaction vessel;
(2) Since the bearing in the bearing chamber is protected from exposure to the fine powders present in the reaction chamber by the partition wall intersecting between the reaction chamber and the bearing chamber, the bearing can be kept in a clean condition;
(3) The pressure equalizing line installed between the reaction chamber and the bearing chamber enables to keep a pressure equalized condition between both the chambers described above and thereby preventing the partition wall from the damage which will be caused by a differential pressure between the reaction chamber and the bearing chamber, and also enables to provide an effect of the gas purge to the pressure equalizing line and thereby reducing an entrance of the fine powders into the bearing chamber from the reaction chamber.

The inventors, however, observed that: a sole measure in which the pressure equalizing line is installed in the horizontal polymerization reactor, the purge gas feed line is connected to the pressure equalizing line, and the gas purge is carried out to the pressure equalizing line, is not sufficient to have an effect of preventing the entrance of the fine powders into the pressure equalizing line from the reaction chamber and a further entrance of the same into the bearing chamber; thus during a long-term operation of the polymerization reactor, the fine powders gradually accumulate in the pressure equalizing line, the bearing chamber and a sliding interface between the agitator shaft and the inner surface of the bearing; that causes a destabilization of the polymerization reaction owing to a choking of the pressure equalizing line and a deterioration of an agitating performance owing to an increase of a friction load on the sliding interface between the agitator shaft and the inner surface of the bearing.

Taking the problems facing the horizontal polymerization reactor designed as described above into consideration, an object of the present invention is to provide a horizontal polymerization reactor for producing a propylene-based polymer by the gas phase polymerization method, which does not give rise to the damage of the partition wall during the long-term operation, and also has an operation stability hard to cause such problems as the destabilization of the polymerization reaction owing to the choking of the pressure equalizing line and the deterioration of the agitating performance owing to the increase of the friction load on the sliding interface between the agitator shaft and the inner surface of the bearing during the long-term operation of the polymerization reactor.

Another object of the present invention is to provide a method for producing a propylene-based polymer with the use of the polymerization reactor having the long-term operation stability described above.

### Solution to Problem

To achieve the above objects, the inventors of the present disclosure conducted investigation and found the following: in the horizontal polymerization reactor for producing a propylene-based polymer by the gas phase polymerization method, a measure in which the pressure equalizing line is installed between the polymerization reaction chamber and the bearing chamber, and a distance in a length direction of the horizontal polymerization reactor, from a position where the polymerization reaction chamber and the catalyst feed nozzle are connected to a position where the polymerization reaction chamber and the pressure equalization line are connected is made to a certain ratio or more of the whole length of the polymerization reaction chamber, makes it harder to give rise to an increase of the differential pressure between the polymerization reaction chamber and the bearing chamber owing to the choking of the pressure equalizing line during the long-term operation, and an deterioration of the agitating performance owing to the increase of the friction load on the sliding interface between the agitator shaft and the inner surface of the bearing.

The first invention of the present disclosure is a horizontal polymerization reactor for producing a propylene-based polymer comprising:
a cylindrical reaction container comprising an internal space, and comprising a polymerization reaction chamber and a bearing chamber which are divided from each other by a partition wall intersecting a length direction of the internal space;
an agitator comprising an agitator shaft rotating in a circumferential direction of the reaction container and an agitating member fixed on the agitator shaft;
a bearing disposed at least one end side of the agitator shaft of the agitator to bear the end portion of the agitator shaft;
a pressure equalization line connecting the polymerization reaction chamber and the bearing chamber,
a purge gas feed line connected at least to the pressure equalization line; and
a catalyst feed nozzle connected to a catalyst feed port of the polymerization reaction chamber,
wherein the agitator shaft of the agitator passes through the partition wall and is placed in the polymerization reaction chamber and the bearing chamber, and the agitating member of the agitator is placed in the polymerization reaction chamber, and the bearing is placed in the bearing chamber,
wherein a distance in a length direction of the polymerization reactor, from a position where the catalyst feed port of the polymerization reaction chamber and the catalyst feed nozzle are connected to a position where the polymerization reaction chamber and the pressure equalization line are connected, is 10% or more of a length of the polymerization reaction chamber.

According to the horizontal polymerization reactor of the first invention described above, it is preferable that a cross sectional-area of a flow path in the pressure equalization line satisfies a relationship represented by the following formula: IA1<IA2, provided that: “IA1” is the cross sectional-area of the flow path at a connecting portion of the pressure equalization line and the polymerization reaction chamber; and “IA2” is the cross sectional-area of the flow path at a connecting portion of the pressure equalization line and the purge gas feed line.

The second invention of the present disclosure is a method for producing a propylene-based polymer, wherein a monomer comprising propylene is polymerized with the use of the horizontal polymerization reactor of the first invention.

According to the method for producing a propylene-based polymer of the second invention described above, it is preferable that a flow rate of the purge gas satisfies a relationship represented by the following formula: FR1>FR2, provided that: “FR1” is the flow rate of the purge gas, in a direction toward the polymerization reaction chamber side, at the connecting portion of the pressure equalization line and the polymerization reaction chamber; and “FR2” is the flow rate of the purge gas, in a direction toward the polymerization reaction chamber side, at the connecting portion of the pressure equalization line and the purge gas feed line.

According to the method for producing a propylene-based polymer of the second invention described above, it is preferable that the flow rate (FR1) of the purge gas, in the direction toward the polymerization reaction chamber side, at the connecting portion of the pressure equalization line and the polymerization reaction chamber are connected is 0.2 m/second or more.

According to the method for producing a propylene-based polymer of the second invention described above, it is preferable that a purge gas comprising propylene is used.

### Advantageous Effects of Invention

According to the present invention, a horizontal polymerization reactor for producing a propylene-based polymer by the gas phase polymerization method, which does not give rise to the damage of the partition wall during the long-term operation, and also has the operation stability hard to cause such problems as the destabilization of the polymerization reaction owing to the choking of the pressure equalizing line and the deterioration of the agitating performance owing to the increase of the friction load on the sliding interface between the agitator shaft and the inner surface of the bearing during the long-term operation of the polymerization reactor, is provided.

In addition, according to the present invention, a method for producing a propylene-based polymer with the use of the polymerization reactor which has a high stability in the long-term operation as described above, is provided.

### BRIEF DESCRIPTION OF DRAWINGS

FIG. 1 is a schematic diagram showing an exemplary gas phase polymerization reactor 100 according to the horizontal polymerization reactor for producing a propylene-based polymer of the present invention.

FIG. 2 is a schematic diagram showing an exemplary horizontal polymerization reactor 200 carrying out the gas phase polymerization process of Comparative Example.

FIG. 3 is an operation data showing the results of demonstration tests in which the horizontal polymerization reactor for producing a propylene-based polymer according to the present invention and the horizontal polymerization reactor of Comparative Example are operated for a long term.

### DESCRIPTION OF EMBODIMENTS

Hereinafter, the features of the horizontal polymerization reactor for producing a propylene-based polymer of the present invention (Hereinafter, it may be called as “a polymerization reactor of the present invention”.) will be described in detail. The descriptions of the components described below are examples of the embodiments of the present invention, and the present invention is not limited to the following descriptions, unless it is beyond the gist thereof.

In the present invention, “to” which indicates a numerical range is used to mean that the described range includes the numerical values described before and after “to”, as the lower limit value and the upper limit value.

The polymerization reactor of the present invention is a horizontal polymerization reactor for producing a propylene-based polymer, which is characterized by comprising:
a cylindrical reaction container comprising an internal space, and comprising a polymerization reaction chamber and a bearing chamber which are divided from each other by a partition wall intersecting a length direction of the internal space;
an agitator comprising an agitator shaft rotating in a circumferential direction of the reaction container and an agitating member fixed on the agitator shaft;
a bearing disposed at least one end side of the agitator shaft of the agitator to bear the end portion of the agitator shaft;
a pressure equalization line connecting the polymerization reaction chamber and the bearing chamber, a purge gas feed line connected at least to the pressure equalization line; and
a catalyst feed nozzle connected to a catalyst feed port of the polymerization reaction chamber,
wherein the agitator shaft of the agitator passes through the partition wall and is placed in the polymerization reaction chamber and the bearing chamber, and the agitating member of the agitator is placed in the polymerization reaction chamber, and the bearing is placed in the bearing chamber,
wherein a distance in a length direction of the polymerization reactor, from a position where the catalyst feed port of the polymerization reaction chamber and the catalyst feed nozzle are connected to a position where the polymerization reaction chamber and the pressure equalization line are connected, is 10% or more of a length of the polymerization reaction chamber.

The polymerization reactor of the present invention is a horizontal polymerization reactor for producing a propylene-based polymer by the gas phase polymerization method.

The propylene-based polymer produced with the use of the polymerization reactor of the present invention includes a propylene homopolymer and propylene copolymers. In a typical use of the polymerization reactor of the present invention, the propylene-based polymer in which a proportion of a repeat unit derived from propylene in the whole of the propylene-based polymer is 50 mol % or more in terms of mole ratio of the repeat unit, or 50 mass % or more in terms of mass ratio of the repeat unit is produced.

The comonomers to be copolymerized with propylene as the main monomer are not particularly limited, and the comonomers to be preferably used are α-olefin monomer different from propylene, which are selected from the group consisting of α-olefin monomers containing 2 or more and 20 or fewer carbon atoms. Examples of α-olefin monomers containing 2 or more and 20 or fewer carbon atoms include ethylene, 1-butene, 3-methyl-1-butene, 4-methyl-1-pentene, 3-methyl-1-pentene, 4-methyl-1-hexene, 4,4-dimethyl-1-hexene, 1-nonene, 1-octene, 1-heptene, 1-hexene, 1-decene, 1-undecene and 1-dodecene.

The gas phase polymerization method is a polymerization process which carries out the polymerization in the gas phase in which the liquid phase is substantially absent. If a phase is substantially gaseous, it is enough for carrying out the polymerization and liquid may be present insofar as it does not deviate from the gist of the present invention. Examples of the liquid include a liquid containing a liquefied monomer for heat removal, and inert hydrocarbon such as hexane which may be used as a solvent for feeding the catalyst. The gas phase polymerization in the present invention also includes a reaction in the liquid phase such that the catalyst diluted with the solvent is fed, and the liquefied monomer dissolved into the solvent is reacted with the fed catalyst.

The horizontal polymerization reactor is a polymerization reactor in which, in the state of being emplaced, the cylindrical reaction vessel is arranged in a direction that makes a central axis (center axis in length direction) running in the length direction of the reaction vessel horizontal (that is, the direction that can be deemed to be perpendicular to the gravity direction in the technical field of the present invention).

The polymerization reactor of the present invention may be applied to the continuous polymerization in which raw material monomers are continuously fed to the reaction vessel and, while developing a polymerization reaction, a polymer thus produced is discharged. In the case of carrying out multistep polymerization with the polymerization reactor of the present invention, two or more polymerization reactors of the present invention may be connected to carry out the multistep polymerization, or the polymerization reactor of the present invention may be connected to a polymerization reactor other than the present invention.

In the polymerization reactor of the present invention, the reaction vessel, which is the cylindrical reaction container, is divided into the polymerization reaction chamber and the bearing chamber by the partition wall intersecting the length direction of the internal space. The polymerization reaction chamber is a main chamber making a field for the polymerization reaction, and the bearing chamber is a chamber holding the bearing therein. In the internal space of the reaction vessel, the partition wall is disposed at one end side in the length direction of the internal space to divide off the bearing chamber, in addition a second partition wall may be disposed at another end side of the internal space.

The agitator has the agitator shaft rotating in a circumferential direction on a trunk portion of the reaction container, and the agitating member fixed on the agitator shaft. The agitating member is a component to load the reaction materials with an agitating force in the reaction chamber, and it may be called as “an agitating blade”. The shape of the agitating member is not particularly limited. For example, it may be a vane shape, a screw shape or the like. There is not any particular limitation on other properties of the agitating member, such as the size (length, width, thickness), the position on the agitator shaft, the azimuth angle around the axis of the agitator shaft, and the inclination angle with respect to the rotational direction, and they may be appropriately determined by taking the agitating force, the force for carrying the materials in the flow direction, or the like into consideration. The agitator is disposed in a state that the agitator shaft penetrates the partition wall to be placed across from the polymerization reaction chamber to the bearing chamber, while the agitating member is placed in the polymerization reaction chamber. Usually, the agitator is arranged in a state that the central axis in the length direction of the internal space of the reaction container is aligned with the agitator shaft of the agitator to coincide with each other.

In a state where the agitator is disposed in the reaction container, one end side of the agitator shaft penetrates the partition wall to reach an inside of the bearing chamber, and it is axis-rotatably born by the bearing which is disposed there. The bearing may be disposed at two or more positions including a position other than the bearing chamber as needed, and those plural bearings may bear the agitator shaft.

In addition, the agitator shaft of the agitator is connected to a drive system such as a motor. By rotating the agitating members of the agitator in the polymerization reaction chamber, homogeneous polymerization can be efficiently carried out, while agitating the starting materials and the reaction product.

The reaction container of the polymerization reactor is provided with: a feed port for feeding starting materials such as catalysts, co-catalysts, main monomers, comonomers, inert solvents and molecular weight regulators to the inside of the polymerization reaction chamber; and a discharge port for discharging a reaction product.

As needed, the reaction container is also provided with the following items: inlet and outlet ports such as a recovery port for recovering unreacted monomers or unreacted gases; sensors for monitoring the condition in the reaction container, such as thermometers and pressure meters; and other apparatuses.

In the present invention, the polymerization reaction chamber and the bearing chamber in the reaction container are connected to each other via the pressure equalizing line which serves as a gas communicating path. The pressure equalizing line thus installed can reduce the differential pressure between the polymerization reaction chamber and the bearing chamber during the long-term operation of the polymerization reactor, and thereby preventing the partition wall from the damage.

In addition, the purge gas feed line is connected to the pressure equalizing line to carry out the gas purge. The gas purge in the pressure equalizing line prevents the fine powders of the propylene-based polymer generated in the polymerization reaction chamber from entering the pressure equalizing line, and it also prevents the same fine powders from passing through the pressure equalizing line and further entering the bearing chamber.

The purge gas feed line is preferably connected to the bearing while it is connected to the pressure equalizing line. The gas purge in the bearing can prevent the fine powders from coming into the sliding interface between the agitator shaft and the inner surface of the bearing, even when the fine powders enter the bearing chamber.

As the purge gas, inert gas such as nitrogen; and gas of raw material monomers and comonomers such as propylene and ethylene, may be usually used. Propylene is particularly preferable in a case like the present invention in which the purge gas is fed through the pressure equalizing line, and finally to the reaction chamber. In the case of using a condensable gas such as propylene, the pressure equalizing line or the purge gas feed line may be wrapped with a tracer, a thermally insulating material or the like.

The pressure equalizing line is disposed so as to be in a state that a distance in the length direction of the polymerization reactor, from the position where the catalyst feed port of the polymerization reaction chamber and the catalyst feed nozzle are connected (That is the position of the catalyst feed port.) to the position where the polymerization reaction chamber and the pressure equalization line are connected, is 10% or more of the length of the polymerization reaction chamber. The distance in the length direction of the polymerization reactor, from the position where the catalyst feed port of the polymerization reaction chamber and the catalyst feed nozzle are connected to the position where the polymerization reaction chamber and the pressure equalization line are connected is preferably 14% or more, and more preferably 20% or more.

In the internal space of the polymerization reaction chamber, since the fine powders of the propylene-based polymer are distributed with a high density at a region in the vicinity of the position where the catalyst feed port of the polymerization reaction chamber and the catalyst feed nozzle are connected, the entrance of the fine powders from the polymerization reaction chamber into the pressure equalization line can be reduced by keeping the position where the polymerization reaction chamber and the pressure equalization line are connected distant away from the position where the catalyst feed port of the polymerization reaction chamber and the catalyst feed nozzle are connected.

The catalyst feed nozzle is a nozzle connected to the catalyst feed port to spray the catalyst from the catalyst feed port into the polymerization reaction chamber. The polymerization reaction chamber and a catalyst feed line are connected via the catalyst feed nozzle. In the present invention, the catalyst feed nozzle may be a nozzle connected to the catalyst feed port for the purpose of spraying not only the catalyst but also the other catalyst components such as the co-catalyst. However, if a nozzle is not intended to spray the catalyst and it is connected to the feed port for the only purpose of spraying the catalyst components other than the catalyst, it is not the catalyst feed nozzle in the present invention. “The catalyst” in the present invention means solid particles having an active site capable of accelerating the polymerization of propylene, and it is distinguished from the other catalyst components such as co-catalyst.

“The distance in the length direction of the polymerization reactor, from the position where the catalyst feed port of the polymerization reaction chamber and the catalyst feed nozzle are connected to the position where the polymerization reaction chamber and the pressure equalization line are connected” means a length of a straight line defined by connecting a center of the inner diameter of the nozzle at the position where the catalyst feed port of the polymerization reaction chamber and the catalyst feed nozzle are connected, and a center of an opening portion at the position where the polymerization reaction chamber and the pressure equalizing line are connected.

“The length of the polymerization reaction chamber” means a length of a straight line defined by connecting the following two intersectional points: an intersectional point where an inner surface at a reaction-upstream end of the polymerization reaction chamber (That is a surface of the partition wall which divides between the polymerization reaction chamber and the bearing chamber, facing toward the polymerization reaction chamber.) intersects the central axis in the length direction of the polymerization reaction chamber; and an intersectional point where an inner surface at a reaction-downstream end of the polymerization reaction chamber intersects the central axis in the length direction of the polymerization reaction chamber.

In a case where a plural number of the positions where the catalyst feed port and the catalyst feed nozzle are connected are present, or in a case where a plural number of the positions where the polymerization reaction chamber and the pressure equalization line are connected are present, the pressure equalization line is disposed so as to make the distance in the length direction of the reactor become 10% or more of the length of the polymerization reaction chamber, even in a combination in which the distance in the length direction of the reactor is the shortest among combinations of the optionally selected position where the catalyst feed port of the polymerization reaction chamber and the catalyst feed nozzle are connected and the optionally selected position where the polymerization reaction chamber and the pressure equalization line are connected.

The cross sectional-area of the flow path in the pressure equalization line is preferable, if it satisfies the relationship represented by the following formula: IA1<IA2, provided that: “IA1” is the cross sectional-area of the flow path at a connecting portion of the pressure equalization line and the polymerization reaction chamber; and “IA2” is the cross sectional-area of the flow path at a connecting portion of the pressure equalization line and the purge gas feed line.

In a case that the cross sectional-area (IA1) of the flow path is made smaller than the cross sectional-area (IA2) of the flow path, a flow rate of the purge gas satisfies the relationship represented by the following formula: FR1>FR2, provided that: “FR1” is the flow rate of the purge gas, in a direction toward the polymerization reaction chamber side, at the connecting portion of the pressure equalization line and the polymerization reaction chamber; and “FR2” is the flow rate of the purge gas, in a direction toward the polymerization reaction chamber side, at the connecting portion of the pressure equalization line and the purge gas feed line. Thus, that makes it possible to eject the purge gas at a high flow rate from the pressure equalization line into the polymerization reaction chamber, thereby preventing the entrance of the fine powders from the polymerization reaction chamber into the pressure equalization line.

When the flow rate (FR1) of the purge gas, in the direction toward the polymerization reaction chamber side, at the connecting portion of the pressure equalization line and the polymerization reaction chamber, that is an ejection speed of the purge gas from the pressure equalization line into the polymerization reaction chamber is set to 0.2 m/second or more, the entrance of the fine powders into the pressure equalization line from the polymerization reaction chamber can be stably prevented.

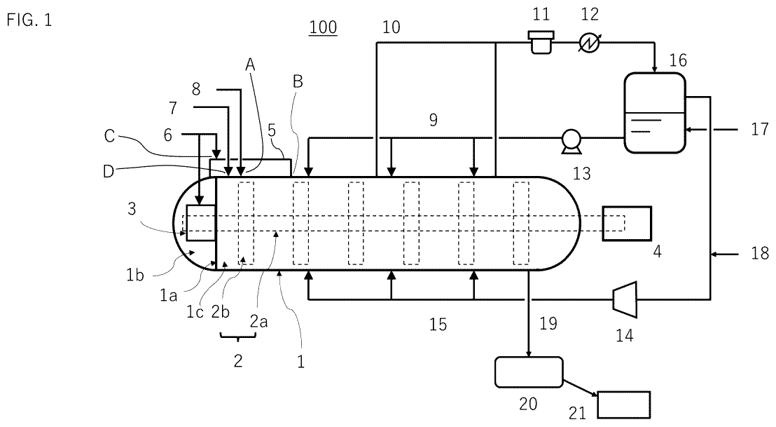

FIG. 1 is a diagram showing an exemplary structure of a polymerization reactor (reactor 100) of the present invention, and the reaction vessel 1, which is the reaction container, is illustrated as a schematic sectional diagram.

In FIG. 1, the reaction vessel 1 is a hollow container in a wholly elongated shape, which is composed of a cylindrical trunk portion and semispherical vessel-end portions connected to both ends of the trunk portion. The reaction vessel 1 is horizontally arranged when the reactor 100 is in the state of being emplaced.

The partition wall la intersecting the length direction of the internal space of the reaction vessel 1 is disposed at a position of a boundary between the trunk portion and the semispherical vessel-end portion at one end side of the vessel, and the polymerization reaction chamber 1c and the bearing chamber 1b are thus divided off by the partition wall 1a.

The polymerization reaction is carried out in the internal space of the polymerization reaction chamber 1c. In the case of the reactor 100, the partition wall 1a is the reaction-upstream end, and the reactor has a reaction space enclosed by the inner surface of the trunk portion of the reaction vessel, the inner surface of the upstream partition wall 1a, and the inner surface of the downstream semispherical end portion.

The internal space of the reaction vessel 1 comprises the polymerization reaction chamber 1c and the bearing chamber 1b, and the agitator 2 comprising at least the agitator shaft 2a rotating in a circumferential direction on a trunk portion of the reaction vessel 1 and agitating blades 2b fixed on the agitator shaft is placed therein.

The agitator 2 is disposed in a state that: a central axis in the length direction of the reaction vessel and the agitator shaft 2a of the agitator are aligned to coincide with each other; the agitator shaft 2a penetrates the partition wall 1a to be placed across from the polymerization reaction chamber 1c to the bearing chamber 1b; and the agitating blades 2b are placed in the polymerization reaction chamber 1c.

The bearing 3 is placed in the bearing chamber 1b provided at one end side of the reaction vessel 1 In addition, as a drive system for axially rotating the agitator shaft, a motor 4 is disposed at the other end side of the reaction vessel 1.

One end of the agitator shaft 2a reaches an inside of the bearing chamber 1b and is inserted into the bearing 3, thereby being axis-rotatably born, while the other end of the agitator shaft 2a penetrates the outer wall of the reaction vessel 1 and is connected to the motor 4.

In the reaction vessel 1, the cocatalyst feed port (In FIG. 1, the position denoted by symbol D) and the catalyst feed port (In FIG. 1, the position denoted by symbol A) are disposed in this order from the upstream side in the vicinity of the reaction-upstream end portion, on a gravity directional upper part of the polymerization reaction chamber 1c. A catalyst feed nozzle (not shown) is connected to the catalyst feed port, and the polymerization reaction chamber 1c and the catalyst feed line 8 are connected via the catalyst feed nozzle. A cocatalyst feed nozzle (not shown) is connected to the cocatalyst feed port, and the polymerization reaction chamber 1c and the cocatalyst feed line 7 are connected via the cocatalyst feed nozzle. Instead that the catalyst feed port and the cocatalyst feed port are individually provided, only one catalyst component feed port for feeding the catalyst and the cocatalyst may be provided and attached with the catalyst feed nozzle feeding the catalyst components such as catalyst and cocatalyst.

In addition, plural raw material monomer feed ports and plural unreacted gas discharge ports are disposed at proper intervals at a downstream side than the catalyst feed port, on a gravity directional upper part of the polymerization reaction chamber 1c. Each of the raw material monomer feed ports is connected to the raw material monomer feed line 9, and each of the unreacted gas discharge ports is connected to the unreacted gas discharge line 10.

On the other hand, in the reaction vessel 1, plural raw material monomer gas feed ports are disposed at proper intervals in a region opposite the raw material monomer feed ports and the unreacted gas discharge ports, on a gravity directional lower part of the polymerization reaction chamber 1c. Each of the raw material monomer gas feed ports is connected to the raw material monomer gas feed line 15.

In addition, a polymer discharge port is disposed in the vicinity of the reaction-downstream end portion, on the gravity directional lower part of the polymerization reaction chamber 1c, and the polymer discharge line 19 is connected thereto.

The polymerization reaction chamber 1c and the bearing chamber 1b of the reaction vessel 1 are provided with a pressure equalization line connecting port respectively, and the pressure equalization line 5 connects to these two ports, thereby connecting the polymerization reaction chamber 1c and the bearing chamber 1b in a state capable of communicating gas.

The purge gas feed lines 6 are connected to the pressure equalization line 5 and the bearing 3 respectively to feed the purge gas from the purge gas feed lines to the pressure equalization line and the bearing.

The purge gas brought to the pressure equalization line 5 is carried through the pressure equalization line, and fed to the polymerization reaction chamber 1c. On the other hand, the purge gas brought to the bearing 3 is fed from a slight gap between the bearing 3 and the agitator shaft 2a to the polymerization reaction chamber 1c.

The pressure equalization line 5 is disposed so as to be in a state that a distance in the length direction of the polymerization reactor, from the position (In FIG. 1, a position denoted by symbol A) where the catalyst feed port of the polymerization reaction chamber 1c and the catalyst feed nozzle are connected to the position (In FIG. 1, a position denoted by symbol B) where the polymerization reaction chamber 1c and the pressure equalization line 5 are connected, is 10% or more of the length of the polymerization reaction chamber.

The method for producing the propylene-based polymer by the gas phase polymerization with the use of the reactor 100 will be described below.

The catalyst is introduced from the catalyst feed port connected with the catalyst feed nozzle, and the cocatalyst is introduced from the cocatalyst feed port connected with the cocatalyst feed nozzle, into the polymerization reaction chamber 1c respectively.

The catalyst is not particularly limited insofar as it can be used for the polymerization of olefin-based monomers. For example, a Ziegler catalyst or a metallocene catalyst can be used. Cocatalyst such as an organoaluminum compound and the other components may be fed from the cocatalyst feed port, or they may be fed as components in the catalyst from the catalyst feed port after they are brought into contact with a solid Ziegler catalyst component or a metallocene complex component. Also, the catalyst may be fed to the reaction vessel in a powder form as it is, or after it is diluted with an inert solvent such as liquid saturated hydrocarbon and mineral oil.

Liquefied propylene and liquefied comonomers as the raw materials are introduced to the polymerization reaction chamber 1c from the plural raw material monomer feed ports connected with the raw material monomer feed line 9. The raw materials in a gaseous state (comonomers, hydrogen or the like) are introduced to the polymerization reaction chamber 1c from the plural raw material monomer gas feed ports connected with the raw material monomer gas feed line 15.

The propylene and the comonomers introduced in the polymerization reaction chamber 1c are brought into contact with the catalyst in the gas phase state and polymerized, while they are agitated with the reaction product by the agitator to synthesize the propylene-based polymer. The hydrogen serves as a molecular weight regulator.

The polymerization conditions of the gas phase polymerization method, such as temperature and pressure, are not particularly limited, and they can be optionally determined according to the raw material monomers. When the raw material monomer is propylene, the reaction temperature, the polymerization pressure and the residence time in the reaction vessel are as follows.

As for the reaction temperature, the lower limit is preferably 0° C. or more, more preferably 30° C. or more, and particularly preferably 40° C. or more; and, the upper limit is preferably 100° C. or less, more preferably 90° C. or less, and particularly preferably 80° C. or less.

As for the polymerization pressure, the lower limit is equal to or more than the atmospheric pressure, and it is preferably 600 kPaG or more, more preferably 1000 kPaG or more, and particularly preferably 1600 kPaG or more; and, the upper limit is preferably 4200 kPaG or less, more preferably 3500 kPaG or less, and particularly preferably 3000 kPaG or less.

The residence time in the reaction vessel is optionally adjusted according to the structure of the reactor product index. In general, the residence time is set in a range of from 30 minutes to 10 hours.

The agitating speed of the agitator is optionally adjusted according to the structure and the size of the reactor or product index. In general, the agitating speed is set as a rotational frequency in a range of from 10 min⁻¹ to 50 min⁻¹.

In the reaction vessel 1, a cross sectional-area of a flow path in the pressure equalization line 5 satisfies a relationship represented by the following formula: IA1<IA2, provided that: “IA1” is the cross sectional-area of the flow path at the position where the pressure equalization line 5 and the polymerization reaction chamber 1c are connected (In FIG. 1, a position denoted by symbol B) ; and “IA2” is the cross sectional-area of the flow path at the position where the pressure equalization line 5 and the purge gas feed line 6 are connected (In FIG. 1, a position denoted by symbol C).

When the cross sectional-area (IA1) of the flow path is made smaller than the cross sectional-area (IA2) of the flow path, a flow rate of the purge gas comes to satisfy the relationship represented by the following formula: FR1>FR2, provided that: “FR1” is the flow rate of the purge gas, in the direction toward the polymerization reaction chamber, at the position where the pressure equalization line and the polymerization reaction chamber are connected (In FIG. 1, a position denoted by symbol B) ; and “FR2” is the flow rate of the purge gas, in the direction toward the polymerization reaction chamber, at the position where the pressure equalization line and the purge gas feed line are connected (In FIG. 1, a position denoted by symbol C).

Thus, that makes it possible to eject the purge gas at a high flow rate from the pressure equalization line into the polymerization reaction chamber, thereby preventing the entrance of the fine powders from the polymerization reaction chamber into the pressure equalization line.

It is particularly preferable that the flow rate of the purge gas at the position where the pressure equalization line and the polymerization reaction chamber are connected (In FIG. 1, a position denoted by symbol B) is set to 0.2 m/second or more in the direction from the position where the pressure equalization line and the purge gas feed line are connected (In FIG. 1, a position denoted by symbol C) to the position where the pressure equalization line and the polymerization reaction chamber are connected.

The polymerization heat generated during the polymerization is removed by the vaporization heat (evaporation latent heat) of the raw material liquefied propylene fed from the raw material monomer feed line 9 disposed on the gravity directional upper part of the polymerization reaction chamber 1. Unreacted propylene gas is discharged to the outside of the reaction system from the unreacted gas discharge line 10 disposed on the gravity directional upper part of the polymerization reaction chamber 1; the discharged unreacted propylene gas passes through a bug filter 11; thereafter, a part of the gas is condensed in a condenser 12; and the condensed gas is separated into a liquid phase and a gas phase in a gas-liquid separation vessel 16. For the removal of the polymerization heat, the separated liquid phase part is carried through the raw material monomer feed line 9 by the driving force of a pump 13, and re-introduced to the plural raw material monomer feed ports disposed on the gravity directional upper part of the polymerization reaction chamber 1c. On the other hand, the separated gas phase part is mixed with comonomer gases, hydrogen for molecular weight control and so on, and the mixture is carried through the raw material monomer gas feed line 15 by the driving force of a compressor 14, and re-introduced to the plural raw material monomer gas feed ports disposed on the gravity directional lower part of the polymerization reaction chamber 1c.

Raw material propylene is supplied to the gas-liquid separation vessel 16 by a propylene and other raw material supply line 17. When other materials (such as comonomers and hydrogen) are gaseous materials, they are supplied into the reaction system by a raw material gas supply line 18. When they are liquid materials, they are supplied into the reaction system by the propylene and other raw material supply line 17.

Polymer particles, which are the reaction product, are transferred from the upstream part to the downstream part in the polymerization reaction chamber, while they are mixed by agitating; they are discharged from the polymer discharge line 19 to the outside of the reaction system; the discharged polymer particles are separated by a gas recovery device 20; and then the separated polymer particles are recovered into a powder recovery device 21.

### EXAMPLES

Hereinafter, the present disclosure will be described in more detail, with reference to examples. However, the present invention is not limited to these examples.

In the following examples, a long-term propylene polymerization was continuously carried out with the use of the horizontal polymerization reactor for producing the propylene-based polymer by the gas phase polymerization method. The polymerization reaction chamber and the bearing chamber in the polymerization reactor were connected to each other via the pressure equalization line, and the purge gas feed lines were connected to the pressure equalization line and the bearing respectively, thus the gas purge was carried out, while the polymerization reaction was carrying out. In the process of the long-term operation of the polymerization reactor, the time-elapse change of the differential pressure between the reaction chamber and the bearing chamber was observed.

### 1. Example 1

The long-term continuous polymerization was carried out in the following polymerization conditions, with the use of the propylene polymerization reactor which is schematically shown in FIG. 1 and has the following structure.

### (1) Structure of Propylene Polymerization Reactor

A horizontal gas phase-polymerization reactor provided with the reaction container having the polymerization reaction chamber with the length of 16 m and the inner diameter at the trunk portion of 2.9 m, and the agitator having the agitator shaft equipped with the agitating blades was used. The rotational frequency of the agitator shaft was 16 min⁻¹.

### (2) Structure and Arrangement of Pressure Equalization Line

The distance in the length direction of the polymerization reactor, from the position where the polymerization reaction chamber and the catalyst feed nozzle are connected to the position where the polymerization reaction chamber and the pressure equalization line are connected, was 5.7 m, and it corresponded to 35% of the length of the polymerization reaction chamber.

The cross sectional-area (IA1) of the flow path in the pressure equalization line at the position where the pressure equalization line and the polymerization reaction chamber are connected was 4.9 cm², and the cross sectional-area (IA2) of the flow path in the pressure equalization line at the position where the pressure equalization line and the purge gas feed line are connected was 11.6 cm². They satisfied the relationship represented by the following formula: IA1<IA2.

### (3) Flow Rate of Purge Gas in Pressure Equalization Line

The flow rate (FR1) of the purge gas, in the direction toward the polymerization reaction chamber, at the position where the pressure equalization line and the polymerization reaction chamber are connected was 0.28 m/second, and the flow rate (FR2) of the purge gas, in the direction toward the polymerization reaction chamber, at the position where the pressure equalization line and the purge gas feed line are connected was 0.13 m/second.

### (4) Polymerization Conditions

Polymerization temperature: 60° C. to 70° C.
Polymerization pressure: 2.2 to 2.5 MPaG
Propylene homo-gas phase polymerization and Propylene ethylene random-gas phase polymerization

### (5) Accumulated Operation Time

Accumulated operation time: About 9 months

### (6) Test Results

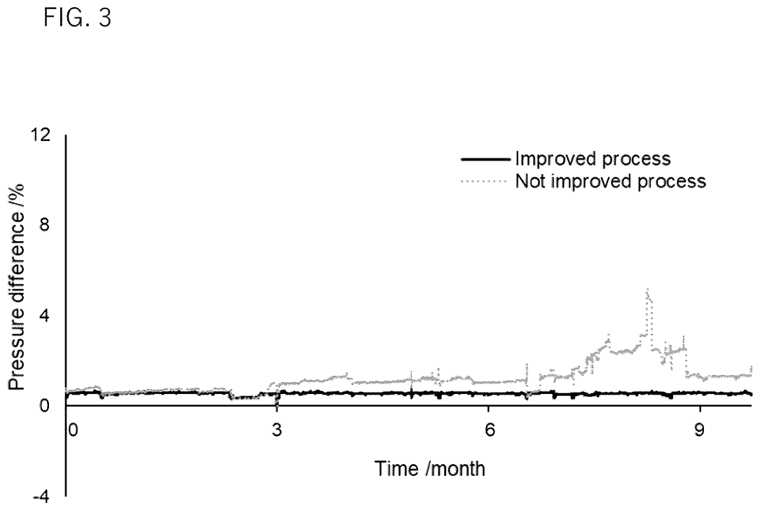

The test result is shown in the graph of FIG. 3 by the solid line (Improved process). The graph of FIG. 3 demonstrates the time-elapse change of the differential pressure between the polymerization reaction chamber and the bearing chamber by taking the horizontal axis for the accumulated operation time, and the vertical axis for a ratio of the differential pressure between the polymerization reaction chamber and the bearing chamber (Pressure difference/%) when an internal pressure of the polymerization reaction chamber is regarded as 100%.

The ratio of the differential pressure between the polymerization reaction chamber and the bearing chamber when the internal pressure of the polymerization reaction chamber is regarded as 100% was about 0.6% at the start of the long-term operation, and it was kept low to the same extent even when the accumulated operation time had passed by about 9 months. The differential pressure was stable during the long-term operation, and a temporary variation of the differential pressure was not observed.

### 2. Comparative Example 1

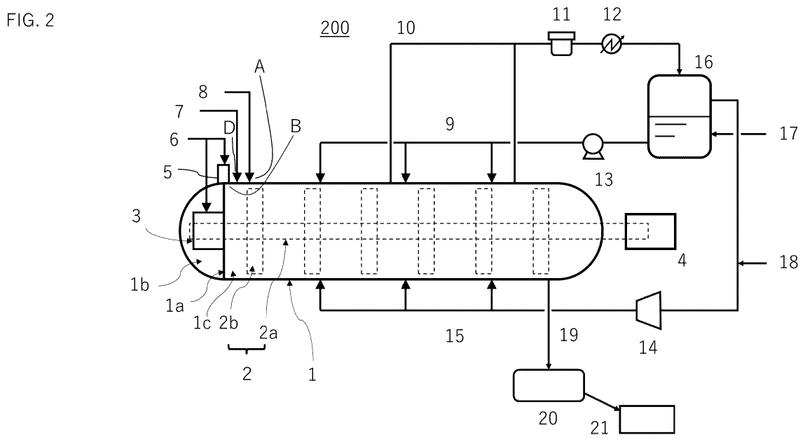

The long-term continuous polymerization was carried out in the following polymerization conditions, with the use of the propylene polymerization reactor which is schematically shown in FIG. 2 and has the following structure.

### (1) Structure of Propylene Polymerization Reactor

A horizontal gas phase-polymerization reactor provided with the reaction container having the polymerization reaction chamber with the length of 16 m and the inner diameter at the trunk portion of 2.9 m, and the agitator having the agitator shaft equipped with the agitating blades was used. The rotational frequency of the agitator shaft was 16 min⁻¹.

### (2) Structure and Arrangement of Pressure Equalization Line

The distance in the length direction of the polymerization reactor, from the position where the polymerization reaction chamber and the catalyst feed nozzle are connected to the position where the polymerization reaction chamber and the pressure equalization line are connected, was 0.62 m, and it corresponded to 3.8% of the length of the polymerization reaction chamber.

The cross sectional-area (IA1) of the flow path in the pressure equalization line at the position where the pressure equalization line and the polymerization reaction chamber are connected was 11.6 cm², and the cross sectional-area (IA2) of the flow path in the pressure equalization line at the position where the pressure equalization line and the purge gas feed line are connected was also 11.6 cm².

### (3) Flow Rate of Purge Gas in Pressure Equalization Line

The flow rate (FR1) of the purge gas, in the direction toward the polymerization reaction chamber, at the position where the pressure equalization line and the polymerization reaction chamber are connected was 0.13 m/second, and the flow rate (FR2) of the purge gas, in the direction toward the polymerization reaction chamber, at the position where the pressure equalization line and the purge gas feed line are connected was also 0.13 m/second.

### (4) Polymerization Conditions

Polymerization temperature: 60° C. to 70° C.
Polymerization pressure: 2.2 to 2.5 MPaG
Propylene homo-gas phase polymerization and Propylene ethylene random-gas phase polymerization

### (5) Accumulated Operation Time

Accumulated operation time: About 9 months

### (6) Test Results

The test result is shown in the graph of FIG. 3 by the dotted line (Not improved process). The graph of FIG. 3 demonstrates the time-elapse change of the differential pressure between the polymerization reaction chamber and the bearing chamber by taking the horizontal axis for the accumulated operation time, and the vertical axis for a ratio of the differential pressure between the polymerization reaction chamber and the bearing chamber (Pressure difference/%) when the internal pressure of the polymerization reaction chamber is regarded as 100%.

The ratio of the differential pressure between the polymerization reaction chamber and the bearing chamber when the internal pressure of the polymerization reaction chamber is regarded as 100% was about 0.6% at the start of the long-term operation. However, the ratio of differential pressure gradually increased from the time when the accumulated operation time had passed by about 3 months, and it became about 1.1% when the accumulated operation time had passed by about 6 months, and then it became about 2.5% when the accumulated operation time had passed by about 9 months.

The differential pressure became unstable from the time when the accumulated operation time had passed by about 6 months, and a temporary steep variation of differential pressure was frequently observed.

### Discussion for Examples

In the polymerization reactor of Comparative Example 1, the distance in the length direction of the polymerization reactor, from the position where the polymerization reaction chamber and the catalyst feed nozzle are connected to the position where the polymerization reaction chamber and the pressure equalization line are connected, was set at a distance corresponding to 3.8% of the length of the polymerization reaction chamber. In this polymerization reactor, the differential pressure between the polymerization reaction chamber and the bearing chamber was gradually increased during the long-term operation, and the differential pressure became unstable as the accumulated operation time extended longer. Based on the result of observation, it is considered that, in the polymerization reactor of Comparative Example 1, the fine powders of the propylene-based polymer were accumulated in the pressure equalization line during the long-term operation, and the choking of the pressure equalization line was then caused.

In the polymerization reactor of Example 1, the distance in the length direction of the polymerization reactor, from the position where the polymerization reaction chamber and the catalyst feed nozzle are connected to the position where the polymerization reaction chamber and the pressure equalization line are connected, was set at a distance corresponding to 35% of the length of the polymerization reaction chamber. In this polymerization reactor, the differential pressure between the polymerization reaction chamber and the bearing chamber did not change during the long-term operation, and the differential pressure was kept low to the same extent obtained at the start of the long-term operation, in addition, the differential pressure was stable even when the accumulated operation time extended longer. Based on the result of observation, it is considered that, in the polymerization reactor of Example 1, the fine powders of the propylene-based polymer were not accumulated in the pressure equalization line during the long-term operation, and the choking of the pressure equalization line was not caused.

### Reference Symbols List

100. Polymerization reactor
1. Reaction vessel
1a. Partition wall
1b. Bearing chamber
1c. Polymerization reaction chamber
2. Agitator
2a. Agitator shaft
2b. Agitating blade
3. Bearing
4. Motor
5. Pressure equalization line
6. Purge gas feed line
7. Cocatalyst feed line
8. Catalyst feed line
9. Raw material monomer feed line
10. Unreacted gas discharge line
11. Bug filter
12. Condenser
13. Pump
14. Compressor
15. Raw material monomer gas feed line
16. Gas-liquid separation vessel
17. Propylene and other raw material supply line
18. Raw material gas supply line (comonomer, hydrogen or the like)
19. Polymer discharge line
20. Gas recovery device
21. Powder recovery device

1. A horizontal polymerization reactor for producing a propylene-based polymer comprising:
a cylindrical reaction container comprising an internal space, and comprising a polymerization reaction chamber and a bearing chamber which are divided from each other by a partition wall intersecting a length direction of the internal space;
an agitator comprising an agitator shaft rotating in a circumferential direction of the reaction container and an agitating member fixed on the agitator shaft;
a bearing disposed at least one end side of the agitator shaft of the agitator to bear the end portion of the agitator shaft;
a pressure equalization line connecting the polymerization reaction chamber and the bearing chamber,
a purge gas feed line connected at least to the pressure equalization line; and
a catalyst feed nozzle connected to a catalyst feed port of the polymerization reaction chamber,
wherein the agitator shaft of the agitator passes through the partition wall and is placed in the polymerization reaction chamber and the bearing chamber, and the agitating member of the agitator is placed in the polymerization reaction chamber, and the bearing is placed in the bearing chamber,
wherein a distance in a length direction of the polymerization reactor, from a position where the catalyst feed port of the polymerization reaction chamber and the catalyst feed nozzle are connected to a position where the polymerization reaction chamber and the pressure equalization line are connected, is 10% or more of a length of the polymerization reaction chamber.

2. The horizontal polymerization reactor for producing a propylene-based polymer according to claim 1, wherein a cross sectional-area of a flow path in the pressure equalization line satisfies a relationship represented by the following formula: IA1<IA2, provided that: “IA1” is the cross sectional-area of the flow path at a connecting portion of the pressure equalization line and the polymerization reaction chamber; and “IA2” is the cross sectional-area of the flow path at a connecting portion of the pressure equalization line and the purge gas feed line.

3. A method for producing a propylene-based polymer, wherein a monomer comprising propylene is polymerized with the use of the horizontal polymerization reactor for producing a propylene-based polymer defined by claim 1.

4. The method for producing a propylene-based polymer according to claim 3, wherein a flow rate of the purge gas satisfies a relationship represented by the following formula: FR1>FR2, provided that: “FR1” is the flow rate of the purge gas, in a direction toward the polymerization reaction chamber side, at a connecting portion of the pressure equalization line and the polymerization reaction chamber; and “FR2” is the flow rate of the purge gas, in a direction toward the polymerization reaction chamber side, at a connecting portion of the pressure equalization line and the purge gas feed line.

5. The method for producing a propylene-based polymer according to claim 3, wherein the flow rate (FR1) of the purge gas, in the direction toward the polymerization reaction chamber side, at a connecting portion of the pressure equalization line and the polymerization reaction chamber is 0.2 m/second or more.

6. The method for producing a propylene-based polymer according to claim 3, wherein a purge gas comprising propylene is used.

7. A method for producing a propylene-based polymer, wherein a monomer comprising propylene is polymerized with the use of the horizontal polymerization reactor for producing a propylene-based polymer defined by claim 2.

8. The method for producing a propylene-based polymer according to Claim 7, wherein a flow rate of the purge gas satisfies a relationship represented by the following formula: FR1>FR2, provided that: “FR1” is the flow rate of the purge gas, in a direction toward the polymerization reaction chamber side, at a connecting portion of the pressure equalization line and the polymerization reaction chamber; and “FR2” is the flow rate of the purge gas, in a direction toward the polymerization reaction chamber side, at a connecting portion of the pressure equalization line and the purge gas feed line.

9. The method for producing a propylene-based polymer according to claim 4, wherein the flow rate (FR1) of the purge gas, in the direction toward the polymerization reaction chamber side, at a connecting portion of the pressure equalization line and the polymerization reaction chamber is 0.2 m/second or more.

10. The method for producing a propylene-based polymer according to claim 7, wherein the flow rate (FR1) of the purge gas, in the direction toward the polymerization reaction chamber side, at a connecting portion of the pressure equalization line and the polymerization reaction chamber is 0.2 m/second or more.

11. The method for producing a propylene-based polymer according to claim 8, wherein the flow rate (FR1) of the purge gas, in the direction toward the polymerization reaction chamber side, at a connecting portion of the pressure equalization line and the polymerization reaction chamber is 0.2 m/second or more.

12. The method for producing a propylene-based polymer according to claim 4, wherein a purge gas comprising propylene is used.

13. The method for producing a propylene-based polymer according to claim 5, wherein a purge gas comprising propylene is used.

14. The method for producing a propylene-based polymer according to claim 7, wherein a purge gas comprising propylene is used.

15. The method for producing a propylene-based polymer according to claim 8, wherein a purge gas comprising propylene is used.

16. The method for producing a propylene-based polymer according to claim 9, wherein a purge gas comprising propylene is used.

17. The method for producing a propylene-based polymer according to claim 10, wherein a purge gas comprising propylene is used.

18. The method for producing a propylene-based polymer according to claim 11, wherein a purge gas comprising propylene is used.
